(19) United States
(12) Patent Application Publication
(10) Pub. No.: US 2004/0061644 A1
(43) Pub. Date: Apr. 1, 2004

(54) CCE calibration with an array of calibration probes interleaved with the array antenna

(75) Inventors: Erik Lier, Newtown, PA (US); Anthony W. Jacomb-Hood, Yardley, PA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Lockheed Martin Corporation, Bethesda, MD (US)

(21) Appl. No.: 10/660,410

(22) Filed: Sep. 10, 2003

Related U.S. Application Data
(60) Provisional application No. 60/409,592, filed on Sep. 11, 2002.

(51) Int. Cl. H01Q 3/22

(52) U.S. Cl. 342/368

(57) ABSTRACT

One embodiment of the invention relates to an antenna system, which comprises an antenna array and a calibration system adapted to calibrate the antenna array. The calibration system can calibrate the antenna array in transmit mode, in receive mode, or in both transmit and receive mode. The antenna array includes a plurality of antenna elements and an antenna beamforming system, and the calibration system includes a plurality of calibration probes integrated with the plurality of antenna elements. The calibration probes may be transmit calibration probes, receive calibration probes, or both. In addition, the calibration system includes a calibration processing system adapted to calibrate the antenna array utilizing the interleaved calibration probes. In one embodiment, the calibration processing systems calibrates the antenna array by performing control circuit encoding (CCE) calibration on the antenna array.

### CROSS-REFERENCES TO RELATED APPLICATIONS

This application claims the benefit of U.S. Provisional Patent Application No. 60/409,592, filed of Sep. 11, 2002, and entitled “CCE Calibration with an Array of Calibration Probes Interleaved with the Array Antenna,” the entirety of which is incorporated herein by reference for all purposes.

### BACKGROUND OF THE INVENTION

The present invention relates generally to calibration of antenna elements of active or passive antenna arrays, and more particularly to a calibration process using a plurality of calibration probes.

Antenna arrays are well known, and are finding increased use in a number of environments, including on spacecraft and in other areas. Active antenna arrays typically include power amplifiers, low-noise amplifiers, or both. In addition, in some applications, the antenna arrays can be configured to operate as both transmit and receive antenna arrays (e.g., a RADAR antenna), and thus include some method for switching from transmit mode to receive mode. This mode of operation is advantageous in that it allows the antenna elements themselves, and possibly the control elements, including the phase shifters and the attenuators (or amplifier gains) to be used for both transmit and receive modes of operation.

In other applications, such as communication repeaters, the communication signals are continuously received, and then continuously retransmitted. For repeater use, active antenna arrays which switch from transmit to receive operation typically are not useful, for they must give up one of transmission or reception while performing the other function. Thus, in repeater applications in is beneficial to have separate receive and transmit antenna arrays.

In spacecraft communication applications, the array typically has multiple beams, and each beam is allocated a certain frequency and/or a particular service or coverage area on the earth. For this, a beamformer with multiple beams are needed. Further, in many applications (e.g., communication spacecraft or RADAR), it is beneficial to have some way to steer the antenna beam(s) of an array antenna. The steering is performed by controlling the phase shifters and/or attenuators associated with each antenna element or group of antenna elements in such a manner as to generate the desired beam shape and/or direction. Antenna controllers, also known as Antenna Control Units (ACU) that provide such control also are well known.

In digitally controlled systems, for example, the phase shifters and the attenuators (which may include gain control of an amplifier) are controlled by digital signals. The smallest unit of control that can be achieved in a digital system typically is defined by a one-bit change in the signal. The phase change provided by a phase shifter, and the attenuation change provided by an attenuator are controlled by a multi-bit control signal, as for example a five-bit control signal, in which any one value represents one of 32 possible states. When the number of bits of the control signal is so limited, the corresponding change in control provided by the phase shifter or attenuator is usually the maximum available change divided by the number of states represented by the control signal. In the five-bit control signal example, assuming that the maximum possible phase shift provided by a phase shifter is 360°, the smallest increment of control is designed to be 360° divided by 32, or slightly more than 10° per bit.

In many circumstances, errors can affect the performance of the antenna. For example, the actual phase shift of a phase shifter, and the actual attenuation of an attenuator, at a given value of the digital control signal (or an analog control signal), may deviate from the nominal value. In addition, errors may be caused by variances in the amplifiers, filters, and distribution circuitry. The accumulation of these errors may substantially affect the accuracy with which the ACU can point the beam(s) in the desired direction, and/or establish the desired beam shape. For this reason, various calibration schemes have been proposed. In this context, the term “calibration” means the process of determining the (one-to-one) relationship between the phase and/or amplitude of the input and output signals of a complete elemental path through the antenna array, including a controllable phase shifter and/or attenuator for a given control input signal state.

One simple calibration scheme is to measure the phase shift of each phase shifter, and the attenuation of each attenuator, before it is mounted in the antenna array, and to provide the resulting data to the ACU as an indication of the expected phase or attenuation of the control unit in the presence of a given digital input signal. This type of calibration scheme, however, does not take into account changes which may occur in the performance of the various control elements due to aging, component manufacturing variances, voltage variations which may be experienced, temperature effects, transmission-line impedance effects, and the like. Thus, it is desirable to have improved calibration arrangements and methods which allow antenna arrays to be calibrated while in an operating environment or otherwise after the antenna array has been in use for a period of time.

### BRIEF SUMMARY OF THE INVENTION

One embodiment of the present invention relates to an antenna system, which comprises an antenna array and a calibration system adapted to calibrate the antenna array. The calibration system can calibrate the antenna array in transmit mode, in receive mode, or in both transmit and receive mode.

In accordance with this embodiment, the antenna array includes a plurality of antenna elements and an antenna beamforming system. In addition, the calibration system comprises a plurality of calibration probes integrated with the plurality of antenna elements. The calibration probes may be transmit calibration probes, receive calibration probes, or both. In some embodiments, the integrated calibration probes are interleaved with the antenna elements. The calibration system further comprises a calibration processing system adapted to calibrate the antenna array utilizing the interleaved calibration probes. In some embodiments, the calibration processing system calibrates the antenna array by performing control circuit encoding (CCE) calibration on the antenna array.

In one embodiment, the calibration processing system comprises a calibration tone signal generator, which generates a calibration tone. The calibration tone is input to the antenna array when the antenna array is in transmit mode, and the calibration tone is input to the plurality of calibration probes when the antenna array is in the receive mode.

The calibration processing system also includes an encoding signal generator, which generates sets of encoding signal values. These sets of encoding signal values are input to the antenna array, which uses them to encode the calibration tone signal traversing the antenna array. The calibration processing system further includes a signal decoding and processing system, which decodes and processes the encoded calibration signals to produce calibration data for the antenna array. In some embodiments, each set of encoding signal values may be orthogonal to other sets of encoding signal values.

In some embodiments, the antenna beamforming system comprises a plurality of phase shifters and/or attenuators, which adjust the phase and/or amplitude of the calibration tone signal based on the sets of encoding signal values, and the signal decoding and processing system produces calibration data representative of the insertion phase and/or amplitude for each elemental path through the beamformer.

In one embodiment of the invention, the antenna array is configured to operate in transmit mode. In accordance with this embodiment, the antenna array receives the calibration tone signal from the calibration tone signal generator, encodes the calibration tone signal with the sets of encoding signal values, generating the encoded calibration signals, and transmits the encoded calibration signals. The calibration probes then receive the encoded calibration signals and transmit the signals to the signal decoding and processing system, which produces the calibration data for the antenna array.

In one embodiment, the antenna beamforming system is adapted to generate a plurality of beams. In accordance with this embodiment, the beamforming system comprises an RF signal path to each element of the antenna array for each of the plurality of beams, and the calibration system is adapted to calibrate the signal paths to each of the antenna elements associate with a particular beam at one time. In addition, each of the antenna elements of the antenna array is radiatively coupled with a plurality of calibration probes (e.g., 2-3), so each antenna elemental path will have multiple calibration data. In accordance with this embodiment, the calibration system further comprises a switch for switching between the plurality of calibration probes, and the signal decoding and processing system decodes and processes encoded calibration signals from the calibration probe to which the switch is connected, generating calibration data for each of the elemental signal paths for the particular calibration probe to which the switch is connected. Thus, the signal decoding and processing system generates calibration data for each of the calibration probes separately, and then the calibration data for each of the elemental signal paths are combined to generate one set of calibration data for each signal path; e.g., calibration corrections for each beam of each antenna elemental path. In some embodiments, the calibration data may be adjusted based-on the location of the associated probe within the antenna array before they are combined.

In accordance with yet another embodiment of the invention, the antenna array is configured to operate in receive mode. In accordance with this embodiment, the plurality of calibration probes receive the calibration tone signal from the calibration tone signal generator and transmit the calibration tone to the antenna array. The antenna array then receives the calibration tone signal from the plurality of calibration probes, encodes the calibration tone signal with the sets of encoding signal values, generating the encoded calibration signals, and transmits the encoded calibration signals the signal decoding and processing system, which produces the calibration data for the antenna array.

Again, the antenna beamforming system may be adapted to generate a plurality of beams, and thus, the beamforming system comprises an RF signal path to each element of the antenna array for each of the plurality of beams, and the calibration system is adapted to calibrate the signal paths to each of the antenna elements associate with a particular beam at one time. Also as mentioned above, each of the antenna elements of the antenna array is radiatively coupled with a plurality of calibration probes (e.g., 2-3), so each antenna elemental path will have multiple calibration data. In some embodiments, the calibration system may further comprise a switch for switching between the plurality of calibration probes, and the antenna array receives and encodes a calibration tone signal transmitted from the calibration probe to which the switch is attached, generating probe encoded calibration signals for each of the elemental signal paths. The signal decoding and processing system then decodes and processes the probe encoded calibration signals, generating calibration data fore each of the signal paths for the particular calibration probe to which the switch is connected. Thus, the signal decoding and processing system generates calibration data for each of the calibration probes separately, and then the calibration data for each of the elemental signal paths are combined to generate one set of calibration data for each path; e.g., calibration corrections for each beam of each antenna elemental path. In some embodiments, the calibration data may be adjusted based-on the location of the associated probe within the antenna array before they are combined.

In some embodiments of the invention, the antenna array may comprise a plurality of antenna arrays, and the plurality of calibration probes then may be integrated and/or interleaved with the plurality of antenna arrays. In some aspects of this embodiment, at least some of the plurality of antenna arrays also may be interleaved with each other.

In yet another embodiment of the present invention, the antenna system may comprise a redundant calibration system. In one embodiment, redundant calibration system may be a duplicate of the initial calibration system. In other embodiments, the redundant calibration system may be the same as the initial calibration system except that the redundant calibration system and the initial calibration system share the same calibration probes.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a perspective view of one embodiment of a spacecraft that may include a calibration system of the present invention;

FIG. 2 is a top view of one embodiment of an antenna array that may be used with the present invention;

FIG. 3 is a block diagram illustrating one embodiment of a calibration system configuration of the present invention;

FIG. 4a is a block diagram illustrating one embodiment of a calibration system having a back-up or redundant configuration; and

FIG. 4b is a block diagram illustrating another embodiment of a calibration system having a back-up or redundant configuration.

### DETAILED DESCRIPTION OF THE INVENTION

The present invention relates generally to calibration of antenna elements of active or passive antenna arrays, and more particularly to a calibration process using a plurality of calibration probes. In some embodiments, control circuit encoding (CCE) calibration may be used. CCE calibration is a calibration technique that employs orthogonal encoding to allow simultaneous measurement of all antenna elements in an antenna array, in situ. The CCE calibration technique uses the beamformer amplitude and/or phase controllers to uniquely encode each of the element path in the array. A calibration probe, coherent receiver, and a decoder are used to recover the unique complex weights of each of the elemental paths for each beam, in situ. One embodiment of a CCE calibration technique is disclosed in U.S. Pat. No. 5,572,219, which issued Nov. 5, 1996 in the name of Silverstein et al., and is entitled “Method and Apparatus for Remotely Calibrating a Phased Array System Used for Satellite Communication,” the entirety of which is incorporated by reference for all purposes.

The CCE calibration technique utilizes a calibration probe which can be placed in the near-field or the far-field of the array. Embodiments of the CCE calibration technique or process which utilizes a calibration probe in both the near-field and the far-field are disclosed in U.S. Pat. No. 6,084,545, which issued on Jul. 4, 2000 in the name of Erik Lier et al., and is entitled “Near-Field Calibration System for Phase-Array Antennas,” and U.S. Pat. No. 6,163,296, which issued on Dec. 19, 2000 in the name of Erik Lier et al., and is entitled “Calibration and lntergrated Beam Control/Conditioning System for Phased-Array Antennas,” both of which are incorporated by reference herein for all purposes. In the near-field application disclosed in those patents, the calibration probe resides on a boom that extends the probe away from and in front of the antenna array.

As noted in both of the Erik Lier et al. patents referenced above, near-field calibration of the phase shifters, amplitude controllers, or both, which are associated with each of the elemental paths for each of the beams of an antenna array provides an improvement over the technique described by Silverstein et al., because the Silverstein technique is a far-field measurement, which requires a remote site, and the need for coherent or synchronous reception between the antenna array and the remote site, which in turn requires a communication path for synchronization. As one skilled in the art will appreciate, this configuration introduces a number of system complications.

The use of one or more near-field probes allows the calibration to be performed in a simpler manner. Knowledge of the radiation patterns of the individual elements of the array, and their locations in the array relative to the calibration probe(s), allow correction factors to be computed. These correction factors then may be used to correct or calibrate the near-field measurements to determine the far-field radiation patterns that result from various phase or amplitude controller settings. These correction factors could apply to either a receive phased-array antenna, a transmit phased-array antenna, or both. Put another way, the near-field probe measurements are used to determine far-field results, so that the phase-shifter and/or amplitude-controller settings associated with the array elements, which give the desired far-field radiation patterns, can be determined. Once the phase shifter and/or amplitude controller settings have been determined or normalized to given far-field patterns, the array is calibrated.

The present invention is directed to a novel calibration approach which utilizes one or more calibration probes integrated with the antenna array. In some embodiments, the CCE calibration approach may be used, but the present invention is not limited to CCE calibration. Other calibration methods may be used. In addition, the present description uses terms such as elemental path, signal path, elemental signal path, and the like. As used herein, those terms are intended to mean the RF signal path through the beamformer connected to each antenna element for each beam. As one skilled in the art will appreciate, the RF signal path may include phase shifters, attenuators, filters, amplifiers, and other circuitry.

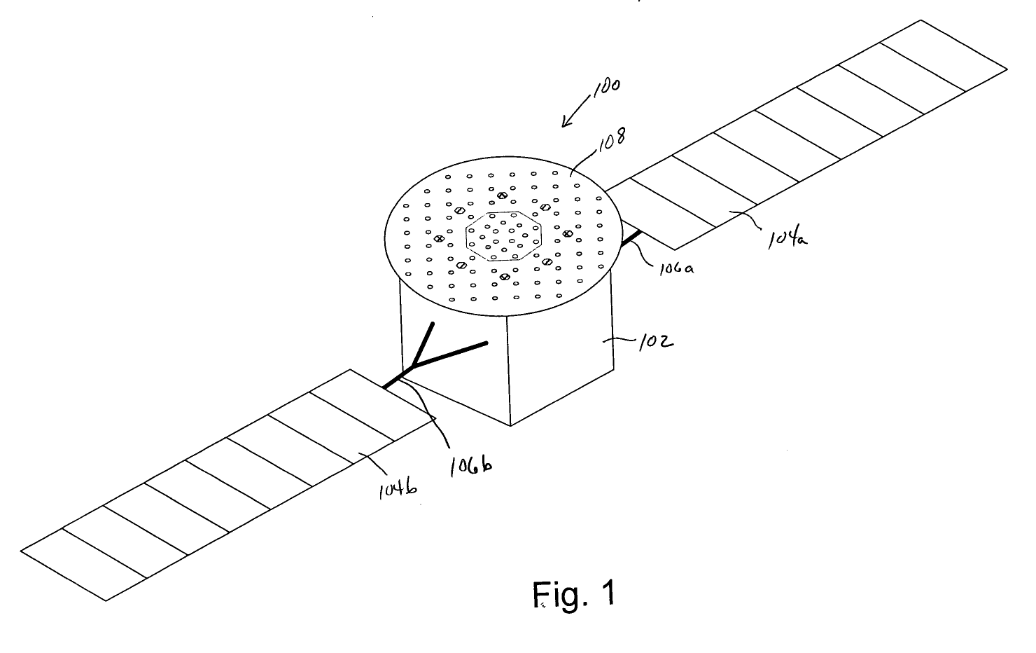

Referring now to FIG. 1, a simplified illustration of a spacecraft on which a calibration arrangement according to an embodiment of the present invention may be mounted is shown. In the illustrated embodiment of FIG. 1, a spacecraft 100 includes a bus or body 102, illustrated as a rectangular block. Bus 102 supports first and second solar panels 104a and 104b, which are mounted (by braces 106a and 106b, respectively) to track the sun, for producing electricity for powering the various electrical portions of spacecraft 100. Bus 102 of spacecraft 100 also supports an array antenna 108, which may be configured as a transmit antenna array, as a receive antenna array, or as both a transmit antenna array and a receive antenna array. In the illustrated embodiment, antenna array 108 resides on a platform that is mounted on bus 102. In other embodiments, however, antenna array 108 may include bus mounted antenna arrays, deployed antenna arrays, a combination of bus mounted antenna arrays and deployed antenna arrays, or any other antenna configuration.

In addition, while one embodiment of the present invention is disclosed herein as an antenna array associated with a spacecraft, the antenna array does not have to be a spacecraft antenna array. In other embodiments, the antenna array and associated calibration system may be used on ground stations, moving vehicles, airplanes and other air platforms, ships and other water vehicles, or any other environment in which antenna arrays are used. Thus, the present invention is not limited to the spacecraft environment disclosed herein.

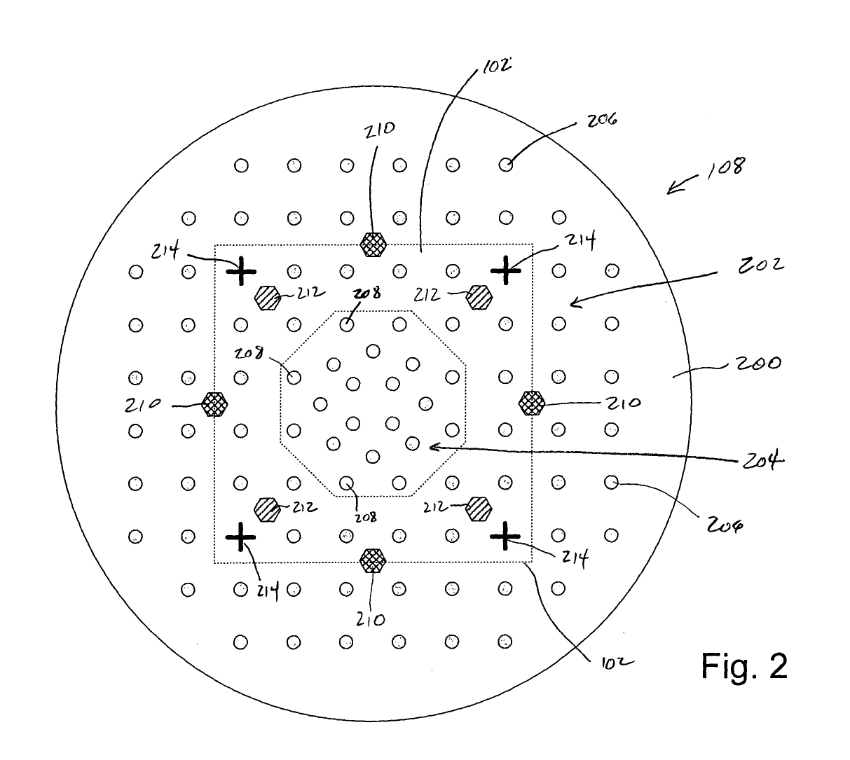

Referring now to FIG. 2, one embodiment of an antenna array 108 having calibration probes integrated with the antenna array is shown. In the illustrated embodiment, antenna array 108 comprises an antenna platform or base 200, a plurality of antenna elements 206, 208, and a plurality of calibration probes 210, 212 integrated in the antenna array. As illustrated in FIG. 1, platform or base 200 may be mounted on the spacecraft bus, which is shown as dotted line 102 in FIG. 2.

Antenna elements 206, 208 may comprise any type of antenna element, such as helical antenna elements, horn antenna elements, dipole antenna elements, patch antenna element, or any other suitable antenna element configuration. In addition, antenna array 108 may comprise any antenna array configuration, including a plurality of antenna arrays configured together. For example, the embodiment illustrated in FIG. 2 comprises a first antenna array 202 having antenna elements 206, and a second antenna array 204 having antenna elements 208. In this particular embodiment, the two antenna arrays are interleaved together, and the calibration probes 210, 212 are integrated into both antenna arrays. Thus, in this particular configuration, the calibration system can be adapted to calibrate both antenna arrays.

Examples of other antenna array configurations with which the calibration system of the present invention may be used are described in U.S. patent app. Ser. No. 10/442,015, filed on May 19, 2003 by Anthony W. Jacomb-Hood et al., and entitled “Concentric Phased Arrays Symmetrically Oriented on the Spacecraft Bus for Yaw-Independent Navigaion,” and U.S. patent app. Ser. No. 10/625,810, filed on Jul. 22, 2003 by Erik Lier et al., and entitled “Partially Interleaved Phased Arrays with Different Antenna Elements in Central and Outer Region,” both of which are incorporated herein by reference for all purposes. One skilled in the art will appreciate that any antenna array configuration can be used, and thus, the present invention is not limited to the antenna arrays disclosed herein, or the antenna arrays disclosed in the incorporated patents.

As mentioned above, calibration probes 210, 212 are integrated with the antenna array(s). In one embodiment, calibration probes are interleaved with the antenna elements of the array(s), as illustrated in FIG. 2. In other embodiments, the calibration probes may be centered in the array or the probes may be placed at the edges of the array(s). In addition, in some embodiments, one calibration probe may be sufficient to handle the calibration of the array; for example, for small arrays. In other embodiments, however, because the calibration probes are integrated in the array and are in relatively close proximity to the array, multiple probes may be needed to communicate with all the elements in the array. As one skilled in the art will appreciate, the number and location of the calibration probes may depend on a number of factors, including, but not limited to, the size of the array, the number of different arrays, the shape or configuration of the array, the type and/or size of antenna elements, the location of the array (e.g., on the bus or deployed), etc. In addition, by providing a plurality of calibration probes radiatively coupled with each of the antenna elements in the array(s), more accurate calibration results may be realized by averaging calibration results from the different probes, or a redundant or back-up system may be employed.

In the embodiment illustrated in FIG. 2, two different sets of antenna arrays 202 and 204 are shown. In one embodiment, each of the two antenna arrays may utilize its own set of probes; for example, probes 210 may be associated with antenna array 202, and probes 212 may be associate with antenna array 204. In other embodiments, the second set of probes may be redundant or back-up probes in case any of the first set of probes is damaged.

In addition, the calibration probes may comprise any type of antenna element, such as dipole elements, horn elements, helical elements, microstrip patch elements, or any other element configuration. The antenna array also may include additional sensors, such as sensors 214 that may comprise earth sensors for pointing, or other frequency antennas or sensors.

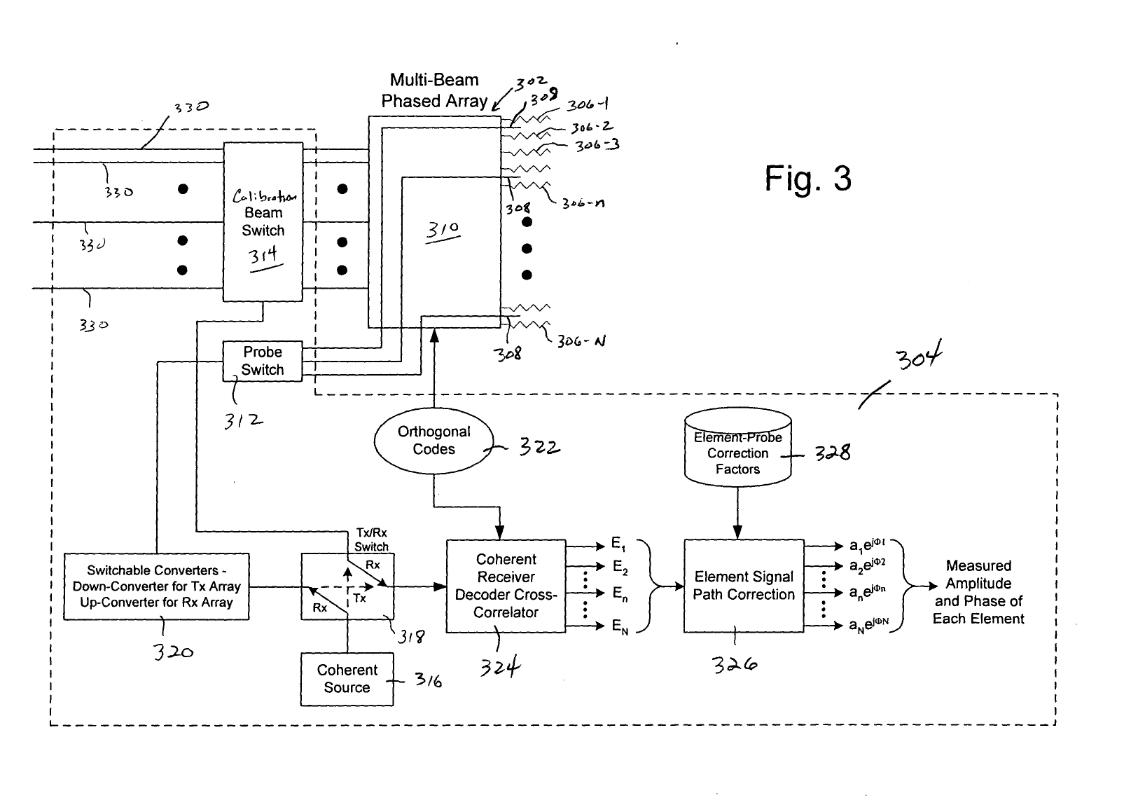

Referring now to FIG. 3, a block diagram illustrating the configuration and operation of one embodiment of a CCE calibration system 300 is shown. In the illustrated embodiment, system 300 comprises an antenna array 302 and a calibration processing system 304. Antenna array 302 comprises a plurality of antenna elements 306 and a plurality of calibration probes 308 integrated into the array. As discussed above, the antenna element and probe configurations may vary based on a number of different factors. Antenna array 302 also comprises beamforming circuitry 310, which can control the phase and/or amplitude of signal beams for each of the antenna elements in the array. In one embodiment, the beamforming circuitry 310 may comprise analog phase shifters and/or attenuator for controlling the phase and/or amplitude of the beams. In another embodiment, beamforming circuitry 310 may comprise a digital beamforming circuit that controls the phase and/or amplitude of beams digitally.

In the illustrated embodiment, calibration processing system 304 comprises a probe switch 312, a calibration beam switch 314, a calibration tone signal source 316, a transmit mode/receive mode switch 318, switchable converter 320, an orthogonal code generator 322, a decoder 324, a correction factor processor 326, and a database 328. Each of these elements will be described in conjunction with describing the calibration process. For ease of reference, the calibration process will be described for a transmit mode antenna.

In accordance with one embodiment of the invention, for a single beam array, the calibration beam switch 314 either connects the antenna beam port to the calibration processing system 304 or to the rest of the payload; e.g., via payload I/Os 330. For a multi-beam array, the calibration beam switch 314 selects up to one beam port to connect to the calibration subsystem 304. The remaining beam ports are left connected to the payload.

Calibration tone generator 316 generates an unmodulated calibration tone and sends it to a beamforming circuitry 310 associated with antenna array 302. In the illustrated embodiment, tone generator 316 is connected to antenna array 302 through transmit mode/receive mode switch 318 and calibration beam switch 314. In this embodiment, calibration beam switch 314 is shown as a separate device, but one skilled in the art will appreciate that in other embodiments, calibration beam switch 314 can be configured as part of beamforming circuitry 310. Also, because the antenna array is in transmit mode, transmit mode/receive mode switch 318 causes tone generator 316 to be connected to antenna array 302 as opposed to probe 308, which is required for receive mode calibration.

Orthogonal code generator 322 generates sets of orthogonal codes and transmits them to beamforming circuitry 310, as suggested by Silverstein et al. The orthogonal codes individually modulate the various phase shifters and amplitude controllers for a given beam with separately identifiable codes, so that the signals applied to the various antenna elements 306-1, 306-2, . . . , 306-n, . . . , 306-N of the array are encoded with the orthogonal codes. Thus, the amplitude and phase weights of the elemental signals, which may be designated a₁e^{jΦ1}, a₂e^{jΦ2}, . . . , aₙe^{jΦn}, . . . , a_{N}e^{jΦN}, respectively, are modulated by the various orthogonal codes. Put another way, the various paths between the calibration tone signal input and each of the individual antenna elements 306-1, 306-2, . . . , 306-n, . . . , 306-N of array 302 are modulated with different codes, so that a unique coding sequence is applied to each of the element paths, by toggling at least one of amplitude and phase so as to provide a unique identifier for the signal path for a given beam.

The probes 308 that are integrated with the antenna elements receive the radiated signals from the antenna elements 306-1, 306-2, . . . , 306-n, . . . , 306-N of array 302 with a phase and amplitude which depends upon the separation rₙ between the individual antenna elements and the probes, and the angular separation as it affects the radiative coupling between the antenna elements and the probes.

As discussed above, because the calibration probes are integrated with the antenna elements and are in relatively close proximity to the antenna elements, multiple probes may be needed to communicate with all the elements in the array. Indeed, depending on the location and configuration of the probes in the array, each of the probes will be radiatively coupled to different sets of antenna elements in the array, with some probes communicating with many of the same elements as other probes in the array. For example, each antenna element will communicate with a plurality of the probes (e.g., 2-3). Thus, to accurately calibrate the entire antenna array, it is beneficial to run the calibration process for each of the probes, adjust the results based on the location of the probes in the array and then combine the results to generate a final calibration result, for example, by averaging. Thus, in this manner, probe switch 312 is used to switch between the probes, so that the calibration process can be run for each probe separately. In addition, in some embodiments, the combination process could weight the results of the measurements from the probes based on the signal-to-noise ratio for a given probe. That is, measurements from probes having higher S/N ratios would be weighted less than measurements from probes having lower S/N ratios. Further, as one skilled in the art will appreciate, to calibrate the array properly, the calibration process is run for each of the beams of the array using the multiple probes for each calibration process.

The signals received by the probes are communicated through probe switch 312 to switchable converter 320, which may translate the signal in frequency. In the transmit mode, switchable converter 320 may be a filter for excluding unwanted signals, a down-converter, or a cascade of a filter with a down-converter. Similarly, in receive mode, switchable converter 320 may operate as a filter, an up-converter, or a combination of both.

From switchable converter 320, the resulting signal, which is a composite of all of the individual signals from the individual antenna elements of the array that are radiatively coupled with the probe being processed are communicated through transmit mode/receive mode switch 318 to decoder 324. Decoder 324 also receives the orthogonal code information, from orthogonal code generator 322, so that the individual elemental signals can be extracted from the composite signal. The resulting unprocessed signals are designated E₁, E₂, . . . , Eₙ, . . . , E_{N}. Each of these signals represents one of the signals flowing in an independent path extending between one of the various individual antenna elements 306-1, 306-2, . . . , 306-n, . . . , 306-N of array antenna 302 and the near-field probe 308 connected to calibration processing system 304 via probe switch 312. Consequently, the unique coding sequence applied to each of the antenna element paths allows for simultaneous measurement of all of the elements for a given beam of the phased-array antenna. More specifically, each of the signals has its relative amplitude and phase aₙe^{jΦn} encoded with the orthogonal coding sequence. One embodiment of a procedure for using a Hadamard matrix to generate the orthogonal encoding and decoding sequences is described in the above mentioned Silverstein et al. patent. Decoder 324 processes the signals received by the probe by cross-correlating the received signal with the orthogonal codes, to produce the unpressed signals E₁, E₂ . . . Eₙ, . . . , E_{N}.

The a priori knowledge of the relative amplitude and phase of the radiative coupling factor between the antenna elements and the calibration probes with reference to the boresight antenna pattern, which may be stored, for example, in database 328 then are used by correction factor processor 326 to compute a correction factor.

Correction factor processor 326 then recovers the relative amplitude and phase weights for each of the antenna elements radiatively coupled with the particular probe being processed. In the illustrated embodiment, decoder 324 and correction factor processor 326 are illustrated as separate units in the circuit. In some embodiments, however, one skilled in the art will appreciate that decoder 324 and correction factor processor 326 can be configured together, or circuit 304 can be configured as a single processing unit.

The calibration system performs the calibration process for each of the probes in the array, generating one or more recovered amplitude and phase weights for each beam of each of the antenna element path in the array. These one or more recovered amplitude and phase weights for each beam of each element path for each of the plurality of calibration probes then are combined to generate a final relative phase and amplitude for each beam of each element path in the receive array, which then are used in a conventional manner to calibrate the array, thereby providing for correction of the far-field pattern.

Calibration of an antenna array in receive mode is performed in a manner corresponding to that of the transmit mode, by applying the calibration tone signal to the transmitting probe 308 connected to probe switch 312, as opposed to antenna array 302. Probe 308 then transmits the calibration tone signal to the receive antenna array, which receives the signal and encodes it with the orthogonal codes in the beamforming circuitry in a manner similar to the transmit mode. The encoded signals then pass through switchable converter 320 (now in receive mode) and switch 318 to decoder 324. The same decoding and scaling procedure then is performed to recover the relative phase and amplitude for each beam of each element of the receive antenna array radiatively coupled with the particular probe being processed. After calibration is performed for all probes in the array, the results are combined to generate a final relative phase and amplitude for each element in the receive array.

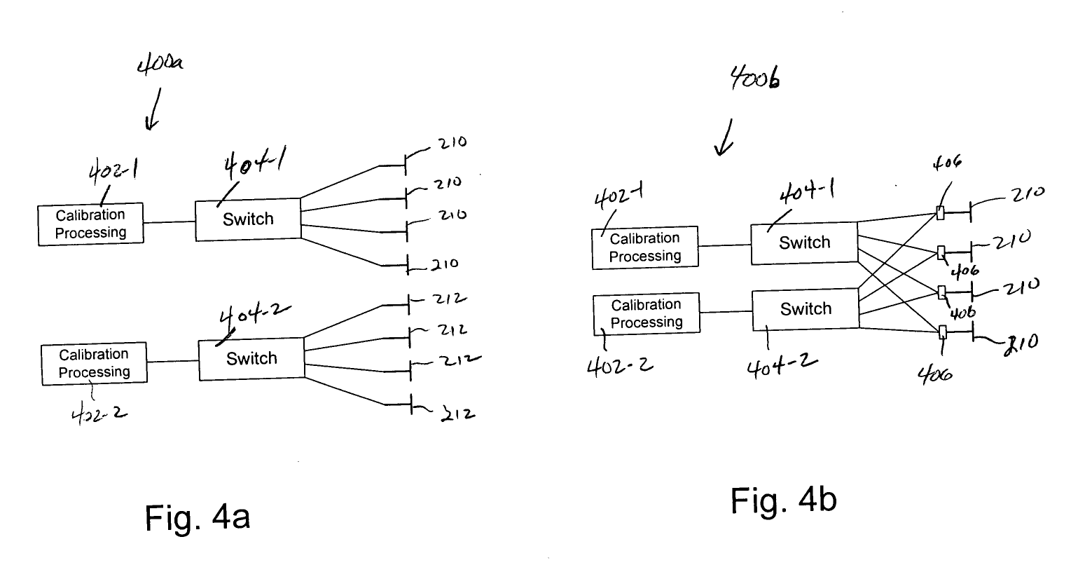

Referring now to FIGS. 4a and 4b, two embodiments of calibration systems having redundant or back-up systems are shown. In the embodiment illustrated in FIG. 4a, the calibration system 400a comprises primary and back-up processing circuitry 402, probe switches 404 and probes 210, 212. In the illustrated embodiment, primary processing circuitry 402-1 in connected primary probes 210 via a primary probe switch 404-1. Similarly, the back-up system comprises a back-up processing circuitry 402-2 connected to back-up probes 212 via back-up probe switch 404-2. Thus, if any of the primary components fail, the back-up system will take over and calibration still can be performed.

FIG. 4b illustrated a second embodiment of a back-up system 400b, which comprise primary and back-up processing circuitry 402 and probe switches 404, but only one set of probes 210. In this embodiment, primary processing circuitry 402-1 is connected to calibration probes 210 via probe switch 404-1, and back-up processing circuitry 402-2 is connected to probes 210 via back-up probe switch 404-2. Both primary probe switch 404-1 and back-up probe switch 404-2 are connected to probes 210 through two-way dividers 406. In this manner, both the primary circuitry 402-1, 404-1 and the back-up circuitry 402-2, 404-2 are connected to probes 210 simultaneously, allowing a switch-over to back-up circuitry to occur quickly and easily. The embodiment in FIG. 4b has the advantage that only one set of calibration probes are needed, thus making is cheaper. This configuration can be utilized because it is rare that probes or antenna elements get damaged; failure typically occurs in the electrical and electro/mechanical configurations.

In conclusion, the present invention provides novel systems, methods and arrangements for calibrating antenna arrays. While detailed descriptions of one or more embodiments of the invention have been given above, various alternatives, modifications, and equivalents will be apparent to those skilled in the art without varying from the spirit of the invention. For example, while the calibration system is described herein with reference to a spacecraft and a spacecraft antenna system, it instead may be used with terrestrial antennas. In addition, other methods may be used for generating sets of coding sequences required for simultaneous measurements of the multiple antenna elements. Therefore, the above description should not be taken as limiting the scope of the invention, which is defined by the appended claims.

What is claimed is:

1. An antenna system, comprising:
an antenna array, comprising:
a plurality of antenna elements; and
an antenna beamforming system;
a calibration system adapted to calibrate the antenna array in either a transmit mode or a receive mode, the calibration system comprising;
a plurality of calibration probes interleaved with the plurality of antenna elements, the calibration probes adapted to be transmit calibration probes or receive calibration probes;
a calibration processing system adapted to calibrate the antenna array utilizing the interleaved calibration probes.

2. The antenna system as recited in claim 1, wherein the calibration processing system calibrates the antenna array by performing control circuit encoding (CCE) calibration on the array.

3. The antenna system as recited in claim 1, wherein the antenna beamforming system is adapted to generate a plurality of beams, and wherein the beamforming system comprises an RF signal path to each element of the antenna array for each of the plurality of beams.

4. The antenna system as recited in claim 3, wherein each signal path comprises a phase shifter, and wherein the calibration system calibrates the phase shifters.

5. The antenna system as recited in claim 3, wherein each signal path comprises an attenuator, and wherein the calibration system calibrates the attenuators.

6. An antenna system, comprising:
an antenna array, comprising:
a plurality of antenna elements; and
an antenna beamforming system;
a calibration system adapted to calibrate the antenna array in either a transmit mode or a receive mode, the calibration system comprising:
a plurality of calibration probes interleaved with the plurality of antenna elements, the calibration probes adapted to be transmit calibration probes or receive calibration probes;
a calibration tone signal generator adapted to generate a calibration tone, wherein the calibration tone is input to the antenna array when the antenna array is in transmit mode, and wherein the calibration tone is input to the plurality of calibration probes when the antenna array is in the receive mode;
an encoding signal generator adapted to generate sets of encoding signal values, and wherein the sets of encoding signal values are input to the antenna array, and the antenna array encodes the calibration tone signal traversing the antenna array with the sets of encoding signal values, generating encoded calibration signals; and
a signal decoding and processing system adapted to decode and process the encoded calibration signals to produce calibration data for the antenna array.

7. The antenna system as recited in claim 6, wherein each set of encoding signal values are orthogonal to other sets of encoding signal values.

8. The antenna system as recited in claim 6, wherein the antenna beamforming system is adapted to generate a plurality of beams, and wherein the beamforming system comprises an RF signal path to each element of the antenna array for each of the plurality of beams.

9. The antenna system as recited in claim 8, wherein each signal path comprises a phase shifter, and wherein the signal decoding and processing system produces calibration data representative of the phase corrections for the phase shifters.

10. The antenna system as recited in claim 8, wherein each signal path comprises an attenuator, and wherein the signal decoding and processing system produces calibration data representative of amplitude corrections for the attenuators.

11. The antenna system as recited in claim 6, wherein the calibration system further comprises a switch for switching between the plurality of calibration probes.

12. The antenna system as recited in claim 6, wherein the antenna array is operating in transmit mode, and wherein the antenna system is adapted such that:
the antenna array receives the calibration tone signal from the calibration tone signal generator, encodes the calibration tone signal with the sets of encoding signal values, generating the encoded calibration signals, and transmits the encoded calibration signals;
one or more of the calibration probes receive the encoded calibration signals and transmit the signals to the signal decoding and processing system; and
the signal decoding and processing system produces the calibration data for the antenna array.

13. The antenna system as recited in claim 12, wherein the antenna beamforming system is adapted to generate a plurality of beams, and wherein the beamforming system comprises an RF signal path to each element of the antenna array for each of the plurality of beams, and wherein the calibration system is adapted to calibrate the signal paths to each of the antenna elements associate with a particular beam at one time, such that each of the encoded calibration signals are associated with each of the signal paths for the particular beam being calibrated.

14. The antenna system as recited in claim 13, wherein each of the antenna elements of the antenna array are radiatively coupled with a plurality of calibration probes, so that each signal path will have a plurality of encoded calibration signals associated with it.

15. The antenna system as recited in claim 14, wherein the calibration system further comprises a switch for switching between the plurality of calibration probes, and wherein the signal decoding and processing system decodes and processes encoded calibration signals from the calibration probe to which the switch is connected, generating calibration data for each of the signal paths for the particular calibration probe to which the switch is connected.

16. The antenna system as recited in claim 15, wherein the signal decoding and processing system generates calibration data for each of the calibration probes separately, and wherein the calibration data for each of the signal paths generated from each of the calibration probes are combined to generate one set of calibration data for each of the signal paths.

17. The antenna system as recited in claim 16, wherein the calibration data for each of the signal paths generated from each of the probes are adjusted based-on the location of the associated probe within the antenna array before the calibration data is combined.

18. The antenna system as recited in claim 16, wherein the calibration data are combined by averaging the calibration data from each of the calibration probes.

19. The antenna system as recited in claim 18, wherein prior to averaging the calibration data from each of the calibration probes, the calibration data from each calibration probe is weighted based on the signal-to-noise ratio for signals from the calibration probes.

20. The antenna system as recited in claim 6, wherein the antenna array is operating in receive mode, and wherein the antenna system is adapted such that:
the plurality of calibration probes receive the calibration tone signal from the calibration tone signal generator and transmit the calibration tone to the antenna array;
the antenna array receives the calibration tone signal from the plurality of calibration probes, encodes the calibration tone signal with the sets of encoding signal values, generating the encoded calibration signals, and transmits the encoded calibration signals to the signal decoding and processing system; and
the signal decoding and processing system produces the calibration data for the antenna array.

21. The antenna system as recited in claim 20, wherein the antenna beamforming system is adapted to generate a plurality of beams, and wherein the beamforming system comprises an RF signal path to each element of the antenna array for each of the plurality of beams, and wherein the calibration system is adapted to calibrate the signal paths to each of the antenna elements associate with a particular beam at one time, such that each of the encoded calibration signals are associated with each of the signal paths for the particular beam being calibrated.

22. The antenna system as recited in claim 21, wherein the calibration system further comprises a switch for switching between the plurality of calibration probes, and wherein the antenna system is adapted such that:
the antenna array receives and encodes a calibration tone signal transmitted from the calibration probe to which the switch is attached, generating probe encoded calibration signals for each of the signal paths; and
the signal decoding and processing system decodes and processes the probe encoded calibration signals, generating a probe calibration data for each of the signal paths for the particular calibration probe to which the switch is connected.

23. The antenna system as recited in claim 22, the signal decoding and processing system generates probe calibration data for each of the calibration probes separately, and wherein the probe calibration data for each of the signal paths generated from each of the probes are combined to generate one set of calibration data for each of the signal paths.

24. The antenna system as recited in claim 23, wherein the probe calibration data for each of the signal paths generated from each of the probes is adjusted based-on the location of the associated probe within the antenna array before the calibration data are combined.

25. The antenna system as recited in claim 23, wherein the calibration data are combined by averaging the calibration data from each of the calibration probes.

26. The antenna system as recited in claim 25, wherein prior to averaging the calibration data from each of the calibration probes, the calibration data from each calibration probe is weighted based on the signal-to-noise ratio for signals from the calibration probes.

27. The antenna system as recited in claim 6, wherein the antenna elements of the antenna array comprise antenna elements selected from the group consisting of helical antenna elements, micro-strip patch antenna elements, horn antenna elements or dipole antenna elements.

28. The antenna system as recited in claim 6, wherein the antenna array comprises a plurality of antenna arrays, and wherein the plurality of calibration probes are interleaved with the plurality of antenna arrays.

29. The antenna system as recited in claim 28, wherein at least some of the plurality of antenna arrays are interleaved with each other.

30. The antenna system as recited in claim 6, wherein the antenna system comprises a redundant calibration system.

31. The antenna system as recited in claim 30, wherein the redundant calibration system is the same as the calibration system.

32. The antenna system as recited in claim 30, wherein the redundant calibration system is the same as the calibration system except that the redundant calibration system and the calibration system share the same calibration probes.

33. A spacecraft including an antenna system, comprising:
an antenna array, comprising:
a plurality of antenna elements; and
an antenna beamforming system;
a calibration system adapted to calibrate the antenna array in either a transmit mode or a receive mode, the calibration system comprising:
a plurality of calibration probes interleaved with the plurality of antenna elements, the calibration probes adapted to be transmit calibration probes or receive calibration probes;
a calibration tone signal generator adapted to generate a calibration tone, wherein the calibration tone is input to the antenna array when then antenna array is in transmit mode, and wherein the calibration tone is input to the plurality of calibration probes when the antenna array is in the receive mode;
an encoding signal generator adapted to generate sets of encoding signal values, and wherein the sets of encoding signal values are input to the antenna array, and the antenna array encodes the calibration tone signal traversing the antenna array with the sets of encoding signal values, generating encoded calibration signals; and
a signal decoding and processing system adapted to decode and process the encoded calibration signals to produce calibration data for the antenna array.

34. The spacecraft as recited in claim 33, wherein each set of encoding signal values are orthogonal to other sets of encoding signal values.

35. The spacecraft as recited in claim 33, wherein the antenna beamforming system is adapted to generate a plurality of beams, and wherein the beamforming system comprises an RF signal path to each element of the antenna array for each of the plurality of beams.

36. The spacecraft as recited in claim 35, wherein each signal path comprises a phase shifter, and wherein the signal decoding and processing system produces calibration data representative of the phase corrections for the phase shifters.

37. The spacecraft as recited in claim 35, wherein each signal path comprises an attenuator, and wherein the signal decoding and processing system produces calibration data representative of amplitude corrections for the attenuators.

38. The spacecraft as recited in claim 33, wherein the calibration system further comprises a switch for switching between the plurality of calibration probes.

39. The spacecraft as recited in claim 33, wherein the antenna array is operating in transmit mode, and wherein the antenna system is adapted such that:
the antenna array receives the calibration tone signal from the calibration tone signal generator, encodes the calibration tone signal with the sets of encoding signal values, generating the encoded calibration signals, and transmits the encoded calibration signals;
one or more of the calibration probes receive the encoded calibration signals and transmit the signals to the signal decoding and processing system; and
the signal decoding and processing system produces the calibration data for the antenna array.

40. The spacecraft as recited in claim 39, wherein the antenna beamforming system is adapted to generate a plurality of beams, and wherein the beamforming system comprises an RF signal path to each element of the antenna array for each of the plurality of beams, and wherein the calibration system is adapted to calibrate the signal paths to each of the antenna elements associate with a particular beam at one time, such that each of the encoded calibration signals are associated with each of the signal paths for the particular beam being calibrated.

41. The spacecraft as recited in claim 40, wherein each of the antenna elements of the antenna array are radiatively coupled with a plurality of calibration probes, so that each signal path will have a plurality of encoded calibration signals associated with it.

42. The spacecraft as recited in claim 41, wherein the calibration system further comprises a switch for switching between the plurality of calibration probes, and wherein the signal decoding and processing system decodes and processes encoded calibration signals from the calibration probe to which the switch is connected, generating calibration data for each of the signal paths for the particular calibration probe to which the switch is connected.

43. The spacecraft as recited in claim 42, wherein the signal decoding and processing system generates calibration data for each of the calibration probes separately, and wherein the calibration data for each of the signal paths generated from each of the calibration probes are combined to generate one set of calibration data for each of the signal paths.

44. The spacecraft as recited in claim 43, wherein the calibration data for each of the signal paths generated from each of the probes are adjusted based-on the location of the associated probe within the antenna array before the calibration data is combined.

45. The spacecraft as recited in claim 43, wherein the calibration data are combined by averaging the calibration data from each of the calibration probes.

46. The antenna system as recited in claim 45, wherein prior to averaging the calibration data from each of the calibration probes, the calibration data from each calibration probe is weighted based on the signal-to-noise ratio for signals from the calibration probes.

47. The spacecraft as recited in claim 33, wherein the antenna array is operating in receive mode, and wherein the antenna system is adapted such that:
the plurality of calibration probes receive the calibration tone signal from the calibration tone signal generator and transmit the calibration tone to the antenna array;
the antenna array receives the calibration tone signal from the plurality of calibration probes, encodes the calibration tone signal with the sets of encoding signal values, generating the encoded calibration signals, and transmits the encoded calibration signals the signal decoding and processing system; and
the signal decoding and processing system produces the calibration data for the antenna array.

48. The spacecraft as recited in claim 47, wherein the antenna beamforming system is adapted to generate a plurality of beams, and wherein the beamforming system comprises an RF signal path to each element of the antenna array for each of the plurality of beams, and wherein the calibration system is adapted to calibrate the signal paths to each of the antenna elements associate with a particular beam at one time, such that each of the encoded calibration signals are associated with each of the signal paths for the particular beam being calibrated.

49. The spacecraft as recited in claim 48, wherein the calibration system further comprises a switch for switching between the plurality of calibration probes, and wherein the antenna system is adapted such that:
the antenna array receives and encodes a calibration tone signal transmitted from the calibration probe to which the switch is attached generating, probe encoded calibration signals for each of the signal paths; and
the signal decoding and processing system decodes and processes the probe encoded calibration signals, generating a probe calibration data for each of the signal paths for the particular calibration probe to which the switch is connected.

50. The spacecraft as recited in claim 49, the signal decoding and processing system generates probe calibration data for each of the calibration probes separately, and wherein the probe calibration data for each of the signal paths generated from each of the probes are combined to generate one set of calibration data for each of the signal paths.

51. The spacecraft as recited in claim 50, wherein the probe calibration data for each of the signal paths generated from each of the probes is adjusted based-on the location of the associated probe within the antenna array before the calibration data are combined.

52. The spacecraft as recited in claim 50, wherein the calibration data are combined by averaging the calibration data from each of the calibration probes.

53. The antenna system as recited in claim 52, wherein prior to averaging the calibration data from each of the calibration probes, the calibration data from each calibration probe is weighted based on the signal-to-noise ratio for signals from the calibration probes.

54. The spacecraft as recited in claim 33, wherein the antenna elements of the antenna array comprise antenna elements selected from the group consisting of helical antenna elements, micro-strip patch antenna elements, horn antenna elements or dipole antenna elements.

55. The spacecraft as recited in claim 33, wherein the antenna array comprises a plurality of antenna arrays, and wherein the plurality of calibration probes are interleaved with the plurality of antenna arrays.

56. The spacecraft as recited in claim 55, wherein at least some of the plurality of antenna arrays are interleaved with each other.

57. The spacecraft as recited in claim 33, wherein the antenna system comprises a redundant calibration system.

58. The spacecraft as recited in claim 57, wherein the redundant calibration system is the same as the calibration system.

59. The spacecraft as recited in claim 57, wherein the redundant calibration system is the same as the calibration system except that the redundant calibration system and the calibration system share the same calibration probes.
